(19) United States
(12) Patent Application Publication
(10) Pub. No.: US 2026/0134551 A1
(43) Pub. Date: May 14, 2026

(54) METHOD AND SYSTEM FOR OPTICAL FLOW ESTIMATION USING LEARNABLE COST VOLUME

(71) Applicant: GWANGJU INSTITUTE OF SCIENCE AND TECHNOLOGY, Gwangju (KR)

(72) Inventors: UEHWAN KIM, Gwangju (KR); Se Hoon OH, Gwangju (KR)

(73) Assignee: GWANGJU INSTITUTE OF SCIENCE AND TECHNOLOGY, Gwangju (KR)

(21) Appl. No.: 19/358,958

(22) Filed: Oct. 15, 2025

(30) Foreign Application Priority Data
Nov. 12, 2024 (KR) 10-2024-0160421

(51) Int. Cl. G06T 7/246; G06T 7/269

(52) U.S. Cl. CPC G06T 7/246; G06T 7/269; G06T 2207/10016; G06T 2207/20081; G06T 2207/20084

(57) ABSTRACT

An optical flow estimation method is provided, the optical flow estimating method includes: generating feature maps from each of a plurality of images; generating a correlation volume by comparing a plurality of feature maps with each other; comparing the plurality of feature maps to generate a first similarity according to comparison in a horizontal direction and a second similarity according to comparison in a vertical direction; generating initial flow data by integrating the first similarity and the second similarity; and generating flow data indicating optical flow for the plurality of images, by correcting the initial flow data based on the correlation volume, the first similarity, and the second similarity.

### CROSS REFERENCE TO RELATED APPLICATION

The present application claims priority to Korean Patent Application No. 10-2024- 0160421, filed on November 12, 2024, the entire contents of which are hereby incorporated by reference in its entirety.

### BACKGROUND OF THE INVENTION

### Field of the Invention

The present invention relates to a method and system for an optical flow estimation using a learnable cost volume.

### Description of the Related Art

An optical flow refers to a technology for estimating pixel-level movement in an image or a video sequence, and may estimate a form in which each pixel moves or is transformed over time. Such optical flow is being actively researched in various application fields such as image analysis, object tracking, video stabilization, augmented reality, robot vision, and autonomous driving vehicles.

Such optical flow, based on pixels on an image moving linearly according to a short time interval and moving while having a predetermined relationship with surrounding pixels, estimates optical flow in various ways by considering both local features and global features in a plurality of images.

In particular, a method has been known in the art that estimates optical flow by estimating the change in optical flow based on the difference in brightness between two images, or by utilizing deep learning models that have been trained on temporal changes in images based on large datasets.

However, estimation of optical flow may exponentially increase a computational load depending on the resolution of the image, and accordingly, a method for estimating optical flow more efficiently and more accurately is required.

### SUMMARY OF THE INVENTION

The present invention relates to a method and system for an optical flow estimation using a learnable cost volume, which may significantly reduce a computational load required in a process of estimating optical flow for a plurality of images.

In addition, the present invention relates to a method and system for an optical flow estimation using a learnable cost volume, which may maintain high performance while shortening the optimization process of optical flow.

To solve the aforementioned objects, there is provided an optical flow estimation method, according to the present invention. The optical flow estimation method may include: generating a feature map from each of a plurality of images; generating a correlation volume by comparing a plurality of feature maps generated from the plurality of images with each other; comparing the plurality of feature maps generated from the plurality of images to generate a first similarity according to comparison in a horizontal direction and a second similarity according to comparison in a vertical direction; generating initial flow data by integrating the first similarity and the second similarity; and generating flow data indicating optical flow for the plurality of images, by correcting the initial flow data based on the correlation volume, the first similarity, and the second similarity.

In addition, there is provided an optical flow estimation system, according to the present invention. The optical flow estimation system may include a storage in which a plurality of images is stored, and a control unit configured to generate flow data indicating optical flow for the plurality of images based on the plurality of images, in which the control unit may generate a feature map from each of the plurality of images, generate a correlation volume by comparing a plurality of feature maps generated from the plurality of images with each other, compare the plurality of feature maps generated from the plurality of images to generate a first similarity according to comparison in a horizontal direction and a second similarity according to comparison in a vertical direction, generate initial flow data by integrating the first similarity and the second similarity, and generate the flow data indicating the optical flow for the plurality of images by correcting the initial flow data based on the correlation volume, the first similarity, and the second similarity.

In addition, there is provided a program stored in a computer-readable recording medium, the program being executed by one or more processes in an electronic device, in which the program may include instructions to allow the program to perform: generating a feature map from each of a plurality of images; generating a correlation volume by comparing a plurality of feature maps generated from the plurality of images with each other; comparing a plurality of feature maps generated from the plurality of images to generate a first similarity according to comparison in a horizontal direction and a second similarity according to comparison in a vertical direction; generating initial flow data by integrating the first similarity and the second similarity; and generating flow data indicating optical flow for the plurality of images by correcting the initial flow data based on the correlation volume, the first similarity, and the second similarity.

According to various embodiments of the present invention, a method and system for an optical flow estimation using a learnable cost volume may consider an inconsistency in a vertical direction and an inconsistency in a horizontal direction, respectively, in feature maps of a plurality of images, and may significantly reduce a computational load required in a process of estimating optical flow for the plurality of images, by estimating the optical flow for the plurality of images based on the inconsistencies.

In addition, according to various embodiments of the present invention, the method and system for an optical flow estimation using a learnable cost volume may estimate an initial flow related to optical flow of the plurality of images, and may maintain high performance while shortening an optimization process of the optical flow, by correcting the previously estimated initial flow based on all pairwise correlations between the plurality of images.

### BRIEF DESCRIPTION OF THE DRAWINGS

FIG. 1 illustrates an embodiment of an optical flow estimation system according to the present invention.

FIG. 2 illustrates an embodiment of an update model.

FIG. 3 illustrates the optical flow estimation system according to the present invention.

FIG. 4 illustrates an optical flow estimation method according to the present invention.

FIG. 5 illustrates an embodiment of generating a feature map for each of a plurality of images.

FIG. 6 illustrates an embodiment of generating a correlation volume.

FIGS. 7 and 8 illustrate an embodiment of generating a first similarity and a second similarity.

FIG. 9 illustrates an embodiment of generating initial flow data.

FIG. 10 illustrates an embodiment of correcting initial flow data.

FIG. 11 is a block diagram illustrating an embodiment of a computing system in which the present invention can be implemented.

FIGS. 12 and 13 are block diagrams illustrating an embodiment of a computing device according to the present invention.

### DETAILED DESCRIPTION OF THE INVENTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The words "module", "unit", "part", and "portion" used to describe constituent elements in the following description are used together or interchangeably in order to facilitate the description, but the words themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as "first," "second," and the like may be used to describe various constituent elements, but the constituent elements are not limited by the terms. These terms are used only to distinguish one constituent element from another constituent element.

When one constituent element is described as being "coupled" or "connected" to another constituent element, it should be understood that one constituent element can be coupled or connected directly to another constituent element, and an intervening constituent element can also be present between the constituent elements. When one constituent element is described as being "coupled directly to" or "connected directly to" another constituent element, it should be understood that no intervening constituent element exists between the constituent elements.

Singular expressions include plural expressions unless clearly described as different meanings in the context.

In the present application, it should be understood that terms "including" and "having" are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

### Overall content of the present invention

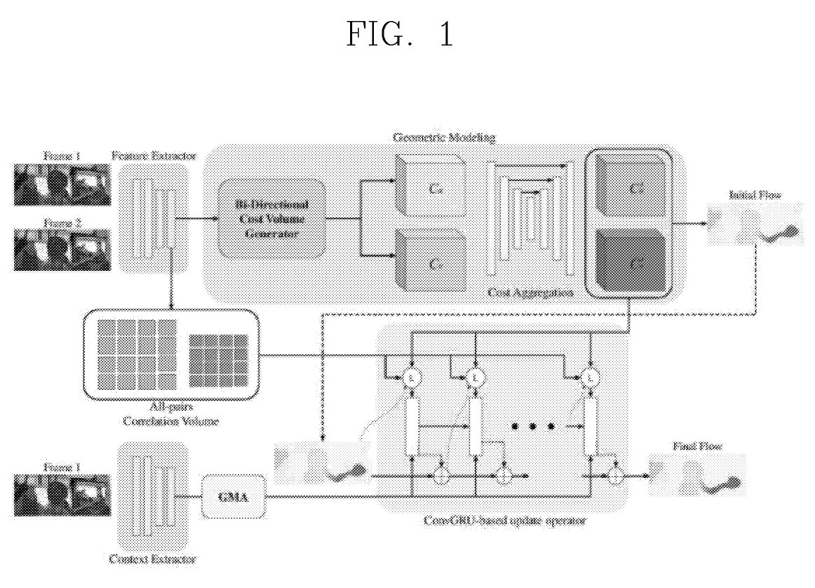

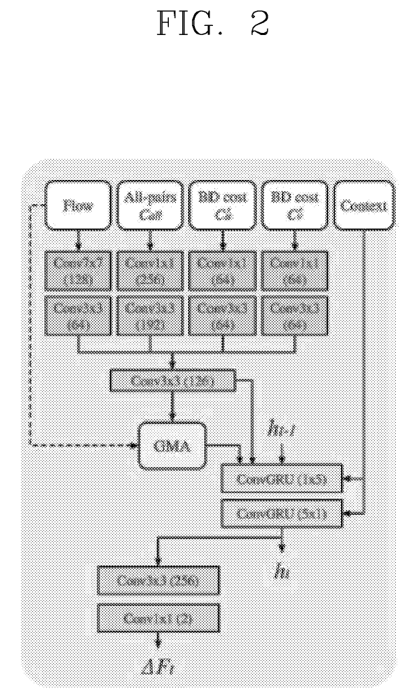

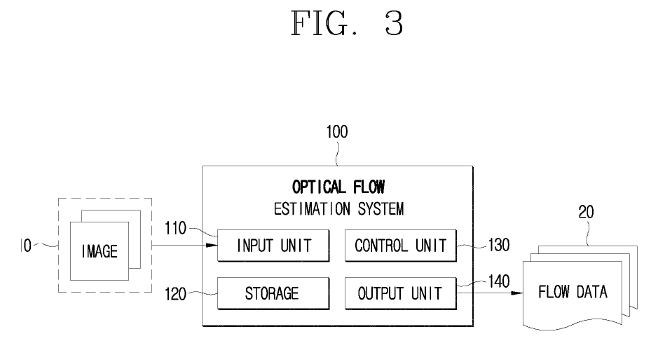

FIG. 1 illustrates an embodiment of an optical flow estimation system according to the present invention. FIG. 2 illustrates an embodiment of an update model. FIG. 3 illustrates the optical flow estimation system according to the present invention.

With reference to FIG. 1, an optical flow estimation system 100 according to the present invention may generate a feature map for each of a plurality of images (e.g., Frame 1, 2), and may generate a first similarity (e.g., Cv) according to comparison in a horizontal direction and a second similarity (e.g., Cu) according to comparison in a vertical direction, by comparing each feature map, and may generate initial flow data (e.g., Initial Flow) by integrating the first similarity and the second similarity, and may generate flow data (e.g., Final Flow) indicating optical flow for the plurality of images, by correcting the initial flow data based on the previously generated data.

Here, the optical flow may refer to a temporal or spatial flow appearing in the plurality of images, and this may include information indicating a change in position of a region (or pixel) having the same pattern in two different images.

For example, the optical flow may include information on an amount of movement according to a difference in position of an object appearing in two images captured at different points in time, or the optical flow may include information on depth according to a difference in position of an object appearing in two images captured at different locations.

In this regard, the flow data may be information indicating a degree of inconsistency between the plurality of images, and may indicate a position difference between a specific pixel in one of the plurality of images and a pixel having a similar pattern to the corresponding pixel in the other. Such flow data may be a correction of the initial flow data based on the correlation volume, the first similarity, and the second similarity, and therefore, the flow data may be generated in the same structure as the initial flow data.

Meanwhile, the plurality of images may include a plurality of images captured at different times or at different positions. For example, the plurality of images may include any two images among a plurality of frames included in a video, or, in another example, the plurality of images may include two images of the same scene captured from the left and right (or from the upper and lower) sides.

The feature map may be output by inputting an image into a pre-trained convolutional neural network (e.g., Feature Extractor), and may be an extraction of information on spatial patterns such as contours (or edges), colors, and shapes appearing in the image.

Here, a convolutional neural network may be trained to generate a feature map corresponding to an image by using preset filters (or kernels) when the image is input. In this case, the convolutional neural network may be trained based on a large-scale general-purpose dataset, or may be trained based on a process of generating flow data from a plurality of images. In such cases, the convolutional neural network may be trained with weights of the convolutional neural network based on a loss between initial flow data and flow data.

Accordingly, the feature map may include a plurality of channels depending on the number of filters (or kernels) provided in the convolutional neural network, and in this case, each channel may be implemented to represent a different spatial pattern from the image. In addition, the feature map may have the same size as each image, and thus, when each image has a structure of H × W × C, each feature map may be generated in a form of H × W × L. Here, H denotes the number of pixels in a vertical direction, W denotes the number of pixels in a horizontal direction, C denotes the color channels (e.g., R, G, B) used in the image, and L may denote the number of channels of the feature map according to the convolutional neural network.

The initial flow data is obtained by integrating a degree of inconsistency for the horizontal direction (i.e., the first similarity) and a degree of inconsistency for the vertical direction (i.e., the second similarity) for the feature map of each of the plurality of images, and may represent a degree of inconsistency considering both the horizontal direction and the vertical direction among the plurality of images.

That is, the initial flow data is generated by integrating the first similarity according to comparison in the horizontal direction and the second similarity according to comparison in the vertical direction, for the plurality of feature maps, and in an embodiment, may be generated based on a bi-directional cost volume. In this case, the bi-directional cost volume may include the first similarity and the second similarity.

In an embodiment, the initial flow data may specify a degree of inconsistency between the plurality of images in a Softmax method with respect to the first similarity and the second similarity (i.e., the bi-directional cost volume). In another embodiment, the initial flow data may be obtained by integrating the first similarity and the second similarity by calculating an average of the first similarity and the second similarity.

Accordingly, the initial flow data may be generated in a form of H × W, when each image has a structure of H × W × C. Here, the initial flow data may include a value indicating a degree of inconsistency between the plurality of images, and in this case, the degree of inconsistency may be specified within a predetermined range (or a predetermined value), depending on the embodiment.

The correlation volume may represent a degree of inconsistency according to all possible pairwise comparisons for the feature map of each of the plurality of images. That is, the correlation volume is obtained by comparing each of a plurality of feature values belonging to one of the plurality of feature maps with a plurality of feature values belonging to another one, and in an embodiment, the correlation volume may be an all-pairs correlation volume. Accordingly, when each image has a structure of H × W × C, the correlation volume may be generated in a form of H × W × H × W × C. Here, the first H × W may represent a size of one of the plurality of images, and the next H × W may represent a size of another one of the plurality of images.

Meanwhile, the first similarity may represent a degree of inconsistency in a horizontal direction between the plurality of images, by comparing feature maps of each of the plurality of images in the horizontal direction. That is, the first similarity may be obtained by comparing each of a plurality of feature values belonging to one of the plurality of feature maps with a plurality of feature values having a same position in a vertical direction among a plurality of feature values belonging to another one. Accordingly, the first similarity may be generated in a form of H × W × W × C when each image has a structure of H × W × C. Here, the first H × W may represent a size of one of the plurality of images, and the next W may represent a size in a horizontal direction of another one of the plurality of images.

The second similarity may represent a degree of inconsistency in a vertical direction between the plurality of images, by comparing feature maps of each of the plurality of images in the vertical direction. That is, the second similarity may be obtained by comparing each of a plurality of feature values belonging to one of the plurality of feature maps with a plurality of feature values having a same position in a horizontal direction among a plurality of feature values belonging to another one. Accordingly, the second similarity may be generated in a form of H × W × H × C when each image has a structure of H × W × C. Here, the first H × W may represent a size of one of the plurality of images, and the next H may represent a size in a vertical direction of another one of the plurality of images.

Meanwhile, with reference to FIG. 2, the optical flow estimation system 100 may correct initial flow data (e.g., Flow) based on a correlation volume (e.g., All-Pairs Call), a first similarity (e.g., BD cost C′v), and a second similarity (e.g., BD cost C′u), by using a pre-implemented update model. Here, the update model may be implemented to estimate a relationship among the initial flow data, the correlation volume, the first similarity, and the second similarity, extract a contextual feature (e.g., Context) from at least one of the plurality of images, and generate correction values for the initial flow data using the previously estimated relationship and the contextual feature.

In an embodiment, the update model may be implemented based on a convolutional gated recurrent unit (ConvGRU).

Accordingly, the optical flow estimation system 100 may generate flow data from initial flow data by repeating a process of correcting the initial flow data using correction values generated from the update model.

With reference to FIG. 3, the optical flow estimation system 100 according to the present invention may include an input unit 110, a storage 120, a control unit 130, and an output unit 140.

The input unit 110 may receive information required for the operation of the optical flow estimation system 100 according to the present invention. To this end, the input unit 110 may be connected to a separate input device, server, or external storage device via a wireless or wired network.

Accordingly, the input unit 110 may receive the plurality of images 10 from a separate input device, server, external storage device, or the like. In addition, according to an embodiment, the input unit 110 may receive a video including a plurality of frames, or may receive images 10 from each of a plurality of different devices.

Meanwhile, the input unit 110 may also receive a user input that is input to generate flow data according to optical flow from the plurality of images 10.

In addition, the storage 120 may store instructions and information required for the operation of the optical flow estimation system 100 according to the present invention. For example, the storage 120 may store the plurality of images 10 input through the input unit 110.

In addition, the storage 120 may store various information generated during a process of generating flow data 20 according to optical flow from the plurality of images 10. For example, the storage 120 may store feature maps corresponding to each image 10, and may store a correlation volume, a first similarity, and a second similarity generated based on the plurality of feature maps, and may store initial flow data generated based on the first similarity and the second similarity. In addition, the storage 120 may store the update model, and may store flow data 20 corrected from the initial flow data based on the update model.

The control unit 130 may control overall operations of the optical flow estimation system 100 according to the present invention. That is, the control unit 130 may generate flow data 20 according to optical flow from the plurality of images 10.

Specifically, the control unit 130 may generate feature maps from each of the plurality of images 10. To this end, the control unit 130 may acquire a plurality of feature maps corresponding to the plurality of images 10, respectively, by inputting each of the plurality of images 10 into a convolutional neural network that is pre-trained to generate a feature map corresponding to a predetermined image.

Accordingly, the control unit 130 may generate a correlation volume by comparing the plurality of feature maps generated from the plurality of images 10 with each other. That is, the control unit 130 may generate the correlation volume according to all pairs between the plurality of feature maps, by comparing each of a plurality of feature values belonging to one of the plurality of feature maps with a plurality of feature values belonging to another one.

In addition, the control unit 130 may generate a first similarity according to comparison in a horizontal direction, and a second similarity according to comparison in a vertical direction, by comparing the plurality of feature maps generated from the plurality of images 10, and may generate initial flow data by integrating the first similarity and the second similarity.

That is, the control unit 130 may generate the first similarity in a horizontal direction for the plurality of feature maps, by comparing each of a plurality of feature values belonging to one of the plurality of feature maps with a plurality of feature values having the same position in a vertical direction among a plurality of feature values belonging to another one, and may generate the second similarity in a vertical direction for the plurality of feature maps, by comparing each of a plurality of feature values belonging to one of the plurality of feature maps with a plurality of feature values having the same position in a horizontal direction among a plurality of feature values belonging to another one.

Further, the control unit 130 may generate initial flow data by integrating paired similarity values for a plurality of similarity values belonging to the first similarity and a plurality of similarity values belonging to the second similarity.

To this end, the control unit 130 may compare a first similarity value, which is one of the plurality of similarity values belonging to the first similarity, with a second similarity value, which corresponds to the same position as the first similarity value among the plurality of similarity values belonging to the second similarity, and may specify a value of the initial flow data at the corresponding position according to the result of the comparison. Through this, the control unit 130 may generate initial flow data by comparing similarity values at the same position as each other, for the plurality of similarity values belonging to the first similarity and the plurality of similarity values belonging to the second similarity.

Further, the control unit 130 may generate flow data 20 indicating optical flow for the plurality of images, by correcting the initial flow data based on the correlation volume, the first similarity, and the second similarity.

To this end, the control unit 130 may estimate a relationship among the initial flow data, the correlation volume, the first similarity, and the second similarity, based on a preset update model, and may correct the initial flow data by generating correction values for the initial flow data based on the estimated relationship.

In this case, the control unit 130 may also extract a contextual feature corresponding to an input image by inputting at least one of the plurality of images into the preset update model, and in such a case, the control unit 130 may also acquire the correction values by considering the previously estimated relationship together with the contextual feature.

Accordingly, the control unit 130 may correct the initial flow data by applying the correction values generated through the preset update model to the initial flow data, and may generate flow data 20 by repeating a correction process for the initial flow data according to a predetermined condition.

The output unit 140 may output the information generated by the operation of the optical flow estimation system 100 according to the present invention. To this end, the output unit 140 may be connected to a separate visual output device, server, external storage device, or the like via a wireless or wired network.

Accordingly, the output unit 140 may output the plurality of images 10, the correlation volume, the first similarity, the second similarity, the initial flow data, and the flow data 20 through a separate output device, server, or external storage device, so that a user may visually identify them, and according to an embodiment, the output unit 140 may also transmit the plurality of images 10, the correlation volume, the first similarity, the second similarity, the initial flow data, and the flow data 20 to another device.

Based on the configuration of the optical flow estimation system 100 described above, an optical flow estimation method will be described in more detail below.

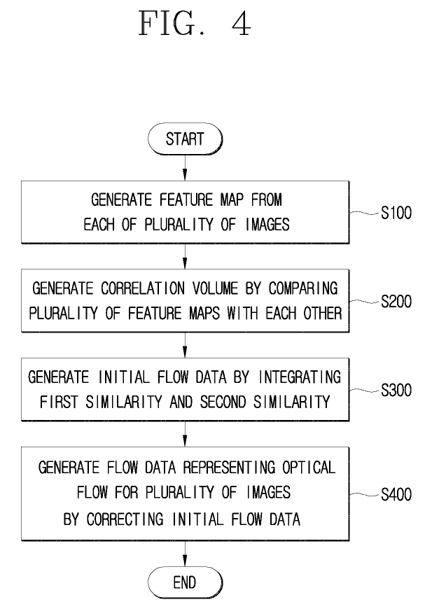

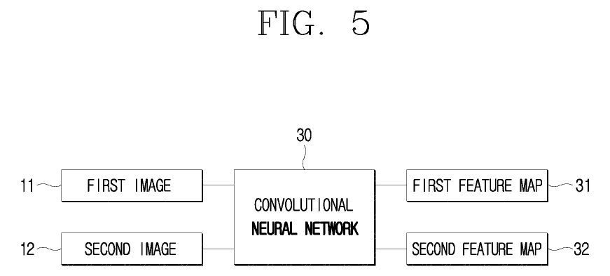

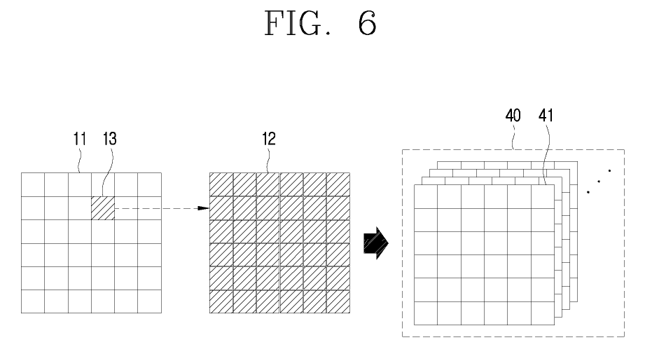

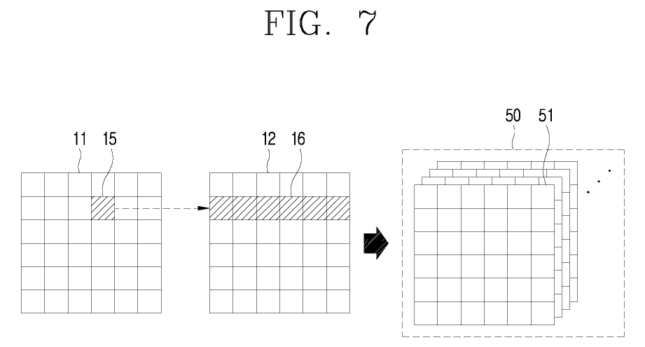

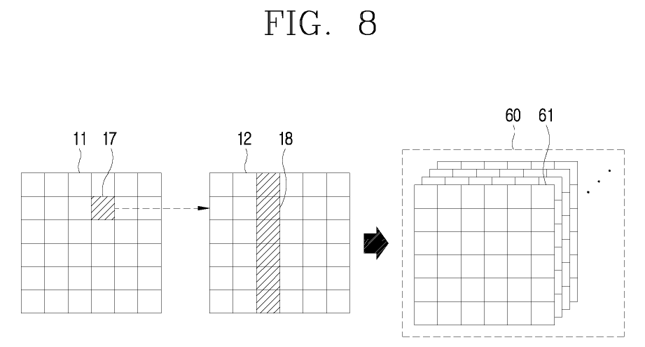

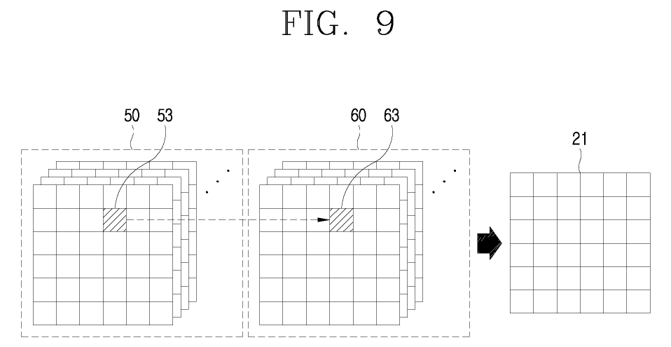

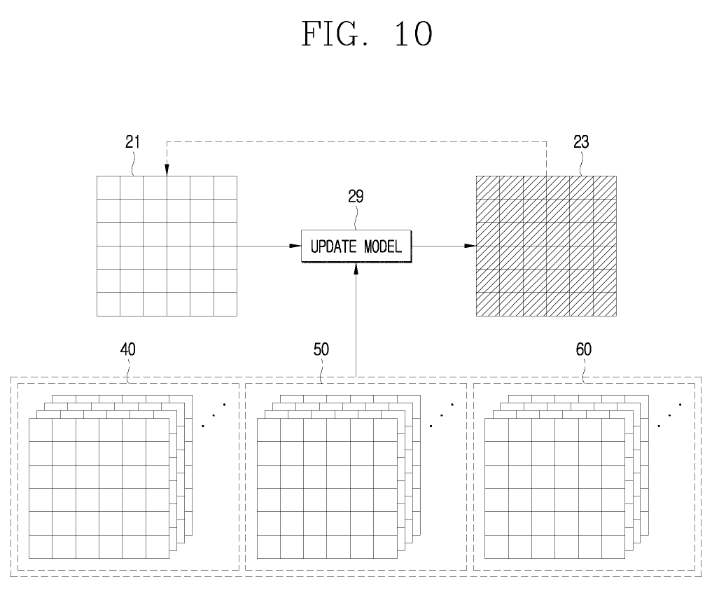

FIG. 4 illustrates an optical flow estimation method according to the present invention. FIG. 5 illustrates an embodiment of generating a feature map for each of a plurality of images. FIG. 6 illustrates an embodiment of generating a correlation volume. FIGS. 7 and 8 illustrate an embodiment of generating a first similarity and a second similarity. FIG. 9 illustrates an embodiment of generating initial flow data. FIG. 10 illustrates an embodiment of correcting initial flow data.

### Feature Map Extraction

With reference to FIG. 4, the optical flow estimation system 100 according to the present invention may generate a feature map from each of a plurality of images (S100).

Specifically, the optical flow estimation system 100 may acquire a plurality of feature maps corresponding to the plurality of images, by inputting each of the plurality of images into a convolutional neural network that is pre-trained to generate a feature map corresponding to an image.

With reference to FIG. 5, for example, the optical flow estimation system 100 may input a first image 11 into a convolutional neural network 30 pre-trained with a predetermined number (e.g., 256) of filters (or kernels), to acquire a first feature map 31, and may input a second image 12 into the convolutional neural network 30 to generate a second feature map 32.

In this case, the optical flow estimation system 100, according to an embodiment, may generate feature maps 31 and 32 having a different number of channels for each color channel of each of the images 11 and 12 through the convolutional neural network 30, or generate feature maps having the same number of channels for each color channel of each of the images 11 and 12, and then integrate the generated feature maps to generate feature maps 31 and 32 having a predetermined number of channels.

In addition, in another embodiment, the optical flow estimation system 100 may integrate color channels of each of the images 11 and 12 into a single channel through a preprocessing process such as grayscale, and may generate feature maps 31 and 32 for the images having the single channel through the convolutional neural network 30.

In still another embodiment, the optical flow estimation system 100 may generate feature maps for each color channel of each of the images 11 and 12 through the convolutional neural network 30, and may also generate a single feature map 31 and 32 in which the feature maps for each color channel are concatenated.

### All Pairs Correlation Volume

With reference back to FIG. 4, the optical flow estimation system 100 according to the present invention may generate a correlation volume by comparing the plurality of feature maps generated from the plurality of images with each other (S200).

Specifically, the optical flow estimation system 100 may generate the correlation volume according to all pairs between the plurality of feature maps, by comparing each of a plurality of feature values belonging to one of the plurality of feature maps with a plurality of feature values belonging to another one.

With reference to FIG. 6, for example, when a first feature map 31 and a second feature map 32 are generated from each of the plurality of images, the optical flow estimation system 100 may generate a correlation map 41 for a specific feature value 13 in the first feature map 31, by comparing the feature value 13 corresponding a specific position in the first feature map 31 with each of a plurality of feature values corresponding to all positions in the second feature map 32.

In this case, the optical flow estimation system 100 may generate a correlation volume 40 including a plurality of correlation maps 41, by comparing each of a plurality of feature values corresponding to all positions in the first feature map 31 with each of a plurality of feature values corresponding to all positions in the second feature map 32, as described above.

Accordingly, the optical flow estimation system 100 may generate a correlation volume 40 including correlation maps 41 having the same size as the second feature map 32, in a number corresponding to the number of a plurality of feature values belonging to the first feature map 31.

In this case, when each of the feature maps 11 and 12 is composed of a plurality of channels, the optical flow estimation system 100 may generate a channel-wise correlation volume according to all feature value pairs in each channel, and may generate the correlation volume 40 by concatenating the plurality of channel-wise correlation volumes.

### Initial Flow Estimation

With reference back to FIG. 4, the optical flow estimation system 100 according to the present invention may compare a plurality of feature maps generated from a plurality of images, generate a first similarity according to comparison in a horizontal direction, generate a second similarity according to comparison in a vertical direction, and generate initial flow data by integrating the first similarity and the second similarity (S300).

Specifically, the optical flow estimation system 100 may generate the first similarity in a horizontal direction for the plurality of feature maps, by comparing each of a plurality of feature values belonging to one of the plurality of feature maps with a plurality of feature values having the same position in a vertical direction among a plurality of feature values belonging to another one, and may generate the second similarity in a vertical direction for the plurality of feature maps, by comparing each of a plurality of feature values belonging to one of the plurality of feature maps with a plurality of feature values having the same position in a horizontal direction among a plurality of feature values belonging to another one.

With reference to FIG. 7, for example, when the first feature map 31 and the second feature map 32 are generated from each of the plurality of images, the optical flow estimation system 100 may compare a feature value 15 corresponding to a specific position in the first feature map 31, with each of a plurality of feature values 16 belonging to the second feature map 32 having the same position in the vertical direction and different positions in the horizontal direction from the specific feature value 15 in the first feature map 31, among a plurality of feature values belonging to the second feature map 32.

In this case, the optical flow estimation system 100 may also compare feature values having different positions in the vertical direction from the specific feature value 15 in the first feature map 31, with each of a plurality of feature values in the second feature map 32 that have the same position in the vertical direction as that of the corresponding feature value and different positions in the horizontal direction from that of the corresponding feature value.

Accordingly, the optical flow estimation system 100 may generate a first similarity map 51 that includes results of comparing a plurality of feature values in the second feature map 32, which have the same position in the vertical direction and different positions in the horizontal direction from a feature value in the first feature map 31, with a plurality of feature values in the first feature map 31 that have the same position in the horizontal direction and different positions in the vertical direction.

In this case, the optical flow estimation system 100 may generate a first similarity 50 including a plurality of first similarity maps 51 by comparing each of a plurality of feature values having different positions in the horizontal direction in the first feature map 31 with each of a plurality of feature values in the second feature map 32, as described above.

Accordingly, the optical flow estimation system 100 may generate the first similarity 50 that includes a first similarity map 51 having the same size in the horizontal direction as the second feature map 32 and the same size in the vertical direction as the first feature map 31 in a number corresponding to the size in the horizontal direction of the first feature map 31.

In this case, the optical flow estimation system 100 may generate a channel-wise first similarity corresponding to each channel when the feature map 11 is composed of a plurality of channels, and may generate the first similarity 50 by concatenating the plurality of channel-wise first similarities.

Meanwhile, with reference to FIG. 8, the optical flow estimation system 100 may compare a feature value 17 corresponding to a specific position in the first feature map 31 with each of a plurality of feature values 18 in the second feature map 32 having the same position in the horizontal direction and different positions in the vertical direction from the specific feature value 17 in the first feature map 31, among a plurality of feature values belonging to the second feature map 32.

In this case, the optical flow estimation system 100 may also compare feature values having different positions in the horizontal direction from the specific feature value 17 in the first feature map 31, with each of a plurality of feature values in the second feature map 32 that have the same position in the horizontal direction as that of the corresponding feature value and different positions in the vertical direction from that of the corresponding feature value.

Accordingly, the optical flow estimation system 100 may generate a second similarity map 61 that includes results of comparing a plurality of feature values in the second feature map 32, which have the same position in the horizontal direction and different positions in the vertical direction from a feature value in the first feature map 31, with a plurality of feature values in the first feature map 31 that have the same position in the vertical direction and different positions in the horizontal direction.

In this case, the optical flow estimation system 100 may generate a second similarity 60 including a plurality of second similarity maps 61, by comparing each of a plurality of feature values having different positions in the vertical direction in the first feature map 31, with each of a plurality of feature values in the second feature map 32, as described above.

Accordingly, the optical flow estimation system 100 may generate the second similarity 60 that includes the second similarity map 61 having the same size in the vertical direction as the second feature map 32 and the same size in the horizontal direction as the first feature map 31 in a number corresponding to the size in the vertical direction of the first feature map 31.

In this case, the optical flow estimation system 100 may generate a channel-wise second similarity corresponding to each channel when the feature map 11 is composed of a plurality of channels, and may generate the second similarity 60 by concatenating the plurality of channel-wise second similarities.

Further, the optical flow estimation system 100 may generate initial flow data by integrating paired similarity values for a plurality of similarity values belonging to the first similarity and a plurality of similarity values belonging to the second similarity.

With reference to FIG. 9, for example, the optical flow estimation system 100 may compare a first similarity value 53, which is one of a plurality of similarity values belonging to the first similarity 50, with a second similarity value 63, which corresponds to the same position as the first similarity value 53 among a plurality of similarity values belonging to the second similarity 60, and may specify the value of the initial flow data 21 at the corresponding position according to the comparison result.

In this case, in an embodiment, the optical flow estimation system 100 may perform Softmax on the first similarity value 53 and the second similarity value 63, and may specify the value of the initial flow data 21 at the corresponding position.

In another embodiment, the optical flow estimation system 100 may specify the greater value of the first similarity value 53 and the second similarity value 63 as the value of the initial flow data 21 at the corresponding position, and in yet another embodiment, the optical flow estimation system 100 may specify the average value of the first similarity value 53 and the second similarity value 63 as the value of the initial flow data 21 at the corresponding position.

In this regard, the optical flow estimation system 100 may compare, for each of a plurality of channels included in each of the first similarity 50 and the second similarity 60, the similarity values at the same position as the first similarity value 53 and the second similarity value 63 and may specify the value of the initial flow data 21 at the corresponding position according to the comparison result.

That is, the optical flow estimation system 100 may extract all similarity values corresponding to a specific position from the first similarity 50 and the second similarity 60, and may specify the value of the initial flow data 21 at the corresponding position by comparing the extracted plurality of similarity values.

Accordingly, the optical flow estimation system 100 may generate the initial flow data 21 by comparing the similarity values at the same position, for a plurality of similarity values belonging to the first similarity 50 and a plurality of similarity values belonging to the second similarity 60.

### Final Cost Volume Generation

With reference back to FIG. 4, the optical flow estimation system 100 according to the present invention may generate flow data representing optical flow for a plurality of images by correcting initial flow data based on the correlation volume, the first similarity, and the second similarity (S400).

Specifically, the optical flow estimation system 100 may estimate a relationship among the initial flow data, the correlation volume, the first similarity, and the second similarity, based on a preset update model, and may correct the initial flow data by generating correction values for the initial flow data based on the estimated relationship.

For example, with reference to FIG. 10, the optical flow estimation system 100 may input the initial flow data 21, the correlation volume 40, the first similarity 50, and the second similarity 60 into the preset update model 29 to estimate the relationship among the initial flow data 21, the correlation volume 40, the first similarity 50, and the second similarity 60.

Here, the estimated relationship may represent a loss among the respective data, and such loss may be calculated as either a maximum difference among the differences of values of the respective data or an average of the differences of the values of the respective data.

Accordingly, the optical flow estimation system 100 may acquire correction values corresponding to the previously estimated relationship through the preset update model 29. In this case, the optical flow estimation system 100 may input at least one of the plurality of images into the preset update model 29 to extract a contextual feature corresponding to the input image. In such a case, the optical flow estimation system 100 may acquire the correction values by taking into account both the previously estimated relationship and the contextual feature.

Here, the preset update model 29 may be implemented to estimate an inconsistency between the initial flow data 21 and the correlation volume 40 by considering the relationship among the initial flow data 21, the correlation volume 40, the first similarity 50, and the second similarity 60, along with the contextual feature for at least one of the plurality of images, based on ConvGRU.

Additionally, the contextual feature may refer to a feature map extracted from at least one image based on a preset convolutional neural network, and in this case, the convolutional neural network may be separately trained to extract global features of the image.

Through this, the optical flow estimation system 100 may correct the initial flow data 21 by applying the correction values generated by the preset update model 29 to the initial flow data, and may generate the flow data 23 by repeatedly performing the correction process of the initial flow data 21 according to a predetermined condition.

Here, the predetermined condition may be defined as either a number of iterations or a threshold for the relationship among the initial flow data 21, the correlation volume 40, the first similarity 50, and the second similarity 60.

Through the above-described configurations, the optical flow estimation system 100 according to the present invention may consider an inconsistency in a vertical direction and an inconsistency in a horizontal direction, respectively, in feature maps of a plurality of images, and may significantly reduce a computational load required in a process of estimating optical flow for the plurality of images, by estimating the optical flow for the plurality of images based on the inconsistencies.

In addition, the optical flow estimation system 100 according to the present invention may estimate an initial flow related to optical flow of the plurality of images, and may maintain high performance while shortening an optimization process of the optical flow, by correcting the previously estimated initial flow based on all pairwise correlations between the plurality of images.

Further, the optical flow estimation system 100 according to the present invention may be implemented through a computing device described below, and may perform data processing related to the above-described optical flow estimation method.

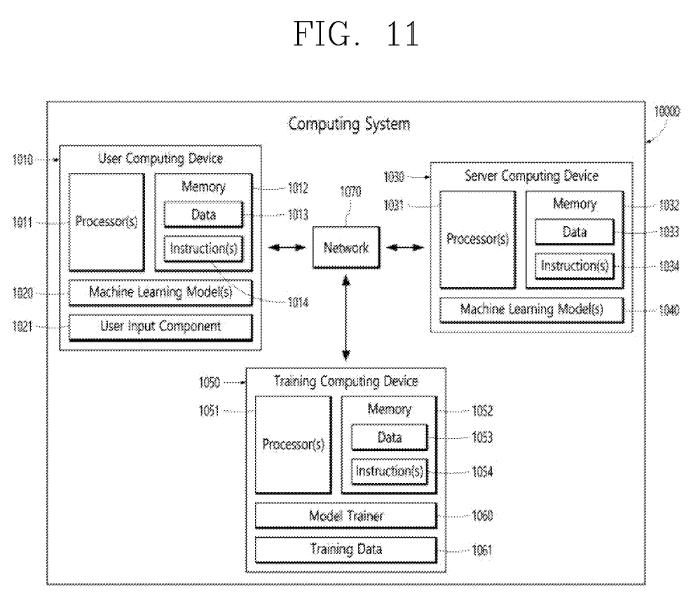

Referring to FIG. 11, a computing system (10000) for performing an method for optical flow estimation using a learnable cost volume according to an embodiment of the present invention may include at least one computing device. In this case, the at least one computing device may be a single-processor or multi-processor computing apparatus.

The components of the at least one computing device of the present invention may include one or more processors, memory, other hardware, and various system components connected (e.g., communicatively, physically, or electrically connected) via a system bus (not shown) that enables data to be transmitted and received among them. The components of the at least one computing device are not limited thereto and may vary widely.

Meanwhile, the at least one computing device included in the computing system (10000) for performing the method for optical flow estimation using a learnable cost volume may be communicatively connected via a network (1070). For example, the at least one computing device included in the computing system (10000) may be clustered or may be part of a local area network (LAN). Additionally, the at least one computing device may be part of a wide area network (WAN) or connected via at least one of a client-server network or a peer-to-peer network within a cloud environment.

Meanwhile, when the at least one computing device is used in at least one environment among a network environment and a cloud computing environment, the at least one computing device may be connected to at least one of a public network and a private network through a network interface or adapter. In one embodiment, other communication connection devices, such as a modem, may be used to establish communication over the network. The modem may be at least one of an internal modem and an external modem, and may be connected to the system bus through a network interface or a specific mechanism. A wireless network component comprising an interface and an antenna may be coupled to the network through devices such as access points or peer computers. In the present invention, the method by which the at least one computing device is communicatively connected via the network (1070) is not limited thereto and may be implemented by means other than the examples described above.

Furthermore, other computer-type devices and/or systems not illustrated in FIG. 11 may technically interact with the at least one computing device or other systems through one or more connections to the network (1070) via a network interface. Here, the network interface may include network interface equipment such as a physical Network Interface Controller (NIC) or a Virtual Interface (VIF).

The network (1070) of the present invention may include various types of networks such as the Internet, Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), 5th Generation Mobile Telecommunication (5G), Bluetooth™, Radio Frequency Identification (RFID), Infrared Data Association (IrDA), Ultra-Wideband (UWB), ZigBee, Near Field Communication (NFC), Wireless Universal Serial Bus (Wireless USB), and the like. In the present invention, data transmission may be performed based on standard communication protocols such as TCP/IP, HTTP, SSL, and others.

The computing system (10000) for performing an method for optical flow estimation using a learnable cost volume according to the present invention may include at least one of a user computing device (1010), a training computing device (1050), and a server computing device (1030).

The user computing device (1010) according to the present invention may be understood as a computing device including at least one processor (1011) and memory (1012) for performing the method for optical flow estimation using a learnable cost volume. For example, the user computing device (1010) may include at least one computing device selected from among a smart phone, smart TV, laptop computer, desktop computer, digital broadcasting terminal, personal digital assistant (PDA), portable multimedia player (PMP), navigation device, slate PC, tablet PC, ultrabook, and wearable device (e.g., smartwatch, smart glass, and head-mounted display (HMD)).

The at least one processor (1011) constituting the user computing device (1010) may include one or more general-purpose processors and/or one or more special-purpose processors. For example, the at least one processor (1011) of the user computing device (1010) may include at least one or a combination of electrically connected processors selected from the group consisting of: a Central Processing Unit (CPU), a Graphics Processing Unit (GPU), a Tensor Processing Unit (TPU), a Neural Processing Unit (NPU), an Arithmetic Logic Unit (ALU), a Floating Point Unit (FPU), an Application-Specific Integrated Circuit (ASIC), a digital signal processing device (DSPD), a programmable logic device (PLD), a Field Programmable Gate Array (FPGA), a controller, a microcontrol unit, a microprocessor, and other electrical units for performing specific functions.

Furthermore, the at least one processor (1011) may be configured to execute computer-readable instructions stored in the memory (1012) and/or other commands described in the present specification.

The memory (1012) constituting the user computing device (1010) according to the present invention may include volatile memory, non-volatile memory, fixed media, removable media, magnetic media, optical media, semiconductor media, and/or other types of physically durable storage media.

For example, the memory (1012) may include one or more non-transitory/transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs the memory storage function over the Internet.

The memory (1012) may store data and instructions necessary for the at least one processor (1011) to perform operations of an application for estimating optical flow using a learnable cost volume.

The user computing device (1010) may include one or more user input components (1021) configured to detect user input. For example, the user input component (1021) may also be referred to as a user interface module. The user input component (1021) may include devices such as a touchscreen, computer mouse, keyboard, keypad, touchpad, trackball, joystick, voice recognition module, or other similar devices. However, the present invention does not limit the types of the user input component (1021).

In this context, the user input component (1021) in the present invention is not necessarily limited to a hardware means but may be understood as a channel through which input is received from a user.

Meanwhile, the "user" in the present invention may also refer to an automated agent, script, playback software, or the like that operates on behalf of one or more human users.

A user may interact with the computing system (10000), which includes at least one computing device, through the user input component (1021) using inputted text, touch, voice, motion, computer vision, gesture, and/or other forms of input/output. For example, the user input component (1021) may include one or more user interface (UI) modalities such as a Command Line Interface (CLI), Graphical User Interface (GUI), Natural User Interface (NUI), voice command interface, and/or other UI representations.

One or more Application Programming Interface (API) calls may be made between the user input component (1021) and the user computing device (1010), based on user input received through a user interface and/or from a network.

Herein, the phrase “based on” may be interpreted to include instances where a particular configuration is used as a foundation, modified from, derived from, influenced by, dependent on, or otherwise originating from such configuration.

In some embodiments, the API call may be configured for a specific API and may be interpreted as, or converted into, an API call configured for a different API. In this context, the API may refer to a defined interface or connection between computers or between computer programs.

In one embodiment, the user computing device (1010) may store one or more machine learning models (1020). For example, the user computing device (1010) may include various machine learning models, such as multiple neural networks (e.g., deep neural networks) for estimating optical flow using a learnable cost volume, or other types of machine learning models including nonlinear models and/or linear models or may be configured as a combination thereof.

According to an embodiment of the present invention, the user computing device (1010) may perform an method for optical flow estimation using a learnable cost volume by utilizing a local and/or external machine learning model (1020). Alternatively, the user computing device (1010) may perform the method for optical flow estimation using a learnable cost volume by utilizing a machine learning model (1040) provided by a server.

According to another embodiment of the present invention, a server computing device (1030) communicating with the user computing device (1010) may provide flow data representing optical flow for a plurality of images to the user computing device (1010) via an application and/or a web interface, in response to a user request received through the user computing device (1010).

According to yet another embodiment of the present invention, at least a portion of the user computing device (1010) and the server computing device (1030) may be cooperatively operated to perform an method for optical flow estimation using a learnable cost volume, thereby providing flow data representing optical flow for a plurality of images to the user.

According to various embodiments of the present invention, the user computing device (1010) and/or the server computing device (1030) may train the machine learning models (1020, 1040) used in method for optical flow estimation using a learnable cost volume through interaction with a training computing device (1050) that is communicatively connected via the network (1070).

In this case, the training computing device (1050) may be a computing system separate from the server computing device (1030). Alternatively, in some embodiments, the training computing device (1050) may be a part of the server computing device (1030) or a part of the user computing device (1010).

Meanwhile, the server computing device (1030) may include at least one processor (1031) and memory (1032). Here, the processor (1031) may include at least one or a combination of electrically connected processors selected from among: a Central Processing Unit (CPU), Graphics Processing Unit (GPU), Tensor Processing Unit (TPU), Neural Processing Unit (NPU), Application-Specific Integrated Circuit (ASIC), Arithmetic Logic Unit (ALU), Floating Point Unit (FPU), digital signal processing devices (DSPDs), programmable logic devices (PLDs), Field Programmable Gate Arrays (FPGAs), controllers, microcontrol units, microprocessors, and/or other electrical units for performing specific functions. For example, the at least one processor (1031) may include circuits and transistors configured to execute instructions from the memory (1032).

The memory (1032) constituting the server computing device (1030) according to the present invention may include volatile memory, non-volatile memory, fixed media, removable media, magnetic media, optical media, semiconductor media, and/or other types of physically durable storage media.

For example, the memory (1032) may include one or more transitory/non-transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs memory storage functions over the Internet.

Additionally, the server computing device (1030) may further include a data store. For example, the data store may be configured as at least one of a relational database, a NoSQL database, a data warehouse, and a local file system.

The memory (1032) constituting the server computing device (1030) according to the present invention may store data and instructions necessary for the at least one processor (1031) to perform operations of an application for estimating optical flow using a learnable cost volume.

In one embodiment, the server computing device (1030) may be configured as a single device or as a plurality of computing devices, which may be configured to operate according to a sequential or parallel computing architecture. Additionally, the system may be implemented as a distributed processing system comprising multiple devices connected over a network.

Meanwhile, the training computing device (1050) may include at least one processor (1051) and memory (1052). A model trainer (1060), as a logical component that performs training of at least one machine learning model (1020, 1040), may be implemented in the form of hardware, firmware, or software.

For example, the model trainer (1060) may load training data (1061) stored in a storage device into the memory (1052), and then be executed by the processor (1051). The model trainer (1060) may be configured to perform one or more operations—such as model training, model reconstruction, model validation, and model testing—on at least one machine learning model.

The machine learning model according to the present invention may include at least one of the following: a statistical model, an algorithm, a neural network (NN), a convolutional neural network (CNN), a generative neural network (GNN), a Word2Vec model, a Bag of Words model, a Term Frequency-Inverse Document Frequency (TF-IDF) model, a Generative Pre-trained Transformer (GPT) model (or other autoregressive models), a Proximal Policy Optimization (PPO) model, a nearest neighbor model (e.g., k-nearest neighbor model), a linear regression model, a k-means clustering model, a Q-learning model, a Temporal Difference (TD) model, a Deep Adversarial Network model, and any other type of model described in the present specification.

Specifically, the model trainer (1060) may perform operations for training a machine learning model, and the operations may include at least one of adding, removing, and modifying model parameters. In this case, the training of the machine learning model may be at least one of supervised learning, semi-supervised learning, and unsupervised learning.

In one embodiment, training of the machine learning model may include a step of repeatedly inputting the training data (1061) based on epochs, and iteratively performing the machine learning model training process configured in this manner. Here, an epoch may refer to a unit representing one complete forward and backward pass of the entire training data (1061) set.

In some implementations, different learning methods (e.g., supervised learning, semi-supervised learning, and unsupervised learning) may be applied at different epochs.

The training data (1061) of the present invention may include input data and/or data previously output from at least one machine learning model (e.g., recursive learning feedback).

The parameters of the at least one machine learning model may include at least one of a seed value, model nodes, model layers, algorithms, functions, connections between different machine learning models, connections between parameters, constraints of the machine learning model, and other digital components that influence the output of the machine learning model.

In this case, a model connection between different machine learning models may include or represent relationships between model parameters and/or between models, which may be dependent, interdependent, hierarchical, and/or static or dynamic.

The combination and configuration of the model parameters described herein may be too complex to be maintained or utilized by human cognitive capabilities.

The present invention does not limit the parameters of machine learning models to those described in the embodiments, and a single machine learning model may include a plurality of model parameters.

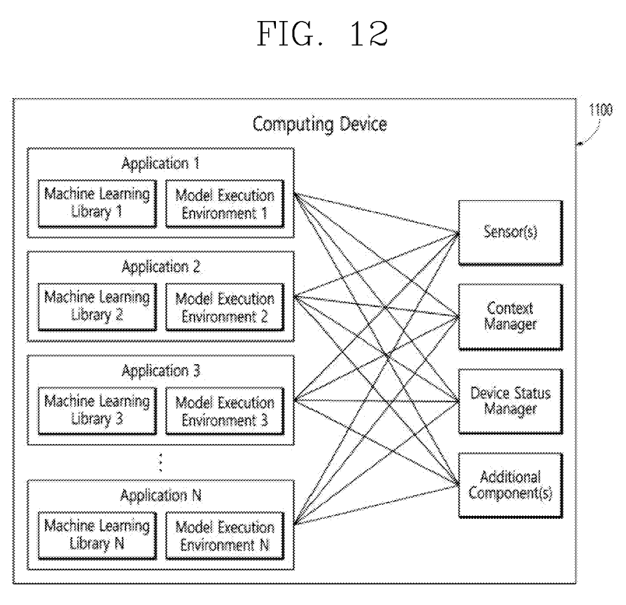

Meanwhile, FIG. 12 illustrates an example block diagram of a computing device (1100), which may be included in the user computing device (1010), the server computing device (1030), or the training computing device (1050), as one embodiment of the computing system (10000) in which the present invention may be implemented.

As shown in FIG. 12, the computing device (1100) may include at least one application (e.g., Application 1 to Application N), and each of the at least one application may include a machine learning library and a model execution environment for performing method for optical flow estimation using a learnable cost volume using machine learning.

Each of the at least one application included in the computing device (1100) may communicate via an Application Programming Interface (API) with one or more components within the computing device (1100), such as sensors, a context manager, a device state manager, or additional components.

In one embodiment, the at least one application may interface with device components by, for example, receiving sensor data or state data via a public or dedicated API, or transmitting prediction results to an output device.

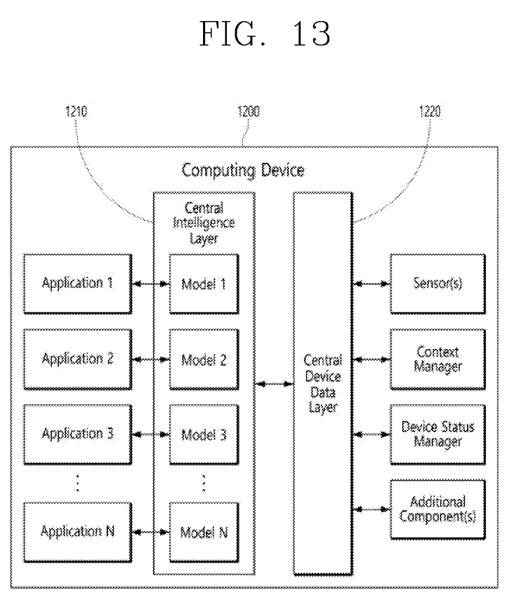

Meanwhile, FIG. 13 illustrates an example block diagram of a computing device (1200), which is one component of the computing system (10000) performing method for optical flow estimation using a learnable cost volume according to an embodiment of the present invention, from another perspective.

The computing device (1200) according to the present invention may include at least one application (e.g., Application 1 to Application N), and each of the at least one application may communicate with a central intelligence layer (1210). Each application may interact with a shared model within the central intelligence layer (1210) via an API (e.g., a common API).

The central intelligence layer (1210) may include one or more machine learning models and may either share them among multiple applications or provide them independently to each application. In one embodiment, the central intelligence layer (1210) may be integrated as part of the operating system or implemented as a separate logical layer.

Additionally, the central intelligence layer (1210) may communicate with a central device data layer (1220). The central device data layer (1220) may integratively store a plurality of images stored within the computing device (1200) and provide them as input data required for optical flow estimation using a learnable cost volume. Each device component (e.g., sensors, state managers, etc.) may communicate with the central device data layer (1220) via a private API or the like.

The technology described in the present specification may be implemented using a single computing device or multiple computing devices. A machine learning model for performing optical flow estimation using a learnable cost volume may be executed sequentially or in parallel on a single component or across multiple distributed components. The data store, machine learning models, and applications may be distributed and operated locally or over a network, and these components may be flexibly applied to various system architectures.

The above has described the implementation of the optical flow estimation system 100 of the present invention as a computing system, but the present invention is not limited thereto. For example, the functionality of the neural network and/or computing device may be distributed among a plurality of computing clusters.

Further, the present invention described above may be implemented as a program executed by one or more processors in an electronic device and stored on a computer-readable recording medium.

Therefore, the present invention may be implemented as computer-readable code or instructions on a medium in which the program is recorded. That is, the various control methods according to the present invention may be provided in the form of a program, either in an integrated or individual manner.

Meanwhile, the computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. An optical flow estimation method processed by a computing device, comprising:
generating a feature map from each of a plurality of images;
generating a correlation volume by comparing a plurality of feature maps generated from the plurality of images with each other;
comparing the plurality of feature maps generated from the plurality of images to generate a first similarity according to comparison in a horizontal direction and a second similarity according to comparison in a vertical direction;
generating initial flow data by integrating the first similarity and the second similarity; and
generating flow data indicating optical flow for the plurality of images, by correcting the initial flow data based on the correlation volume, the first similarity, and the second similarity.

2. The optical flow estimation method of claim 1, wherein the generating of the feature map comprises:
inputting each of the plurality of images into a convolutional neural network pre-trained to generate a feature map corresponding to a predetermined image, and acquiring a plurality of feature maps corresponding to the plurality of images, respectively.

3. The optical flow estimation method of claim 1, wherein the generating of the correlation volume comprises:
generating the correlation volume according to all pairs between the plurality of feature maps, by comparing each of a plurality of feature values belonging to one of the plurality of feature maps with a plurality of feature values belonging to another one.

4. The optical flow estimation method of claim 1, wherein the generating of the initial flow data comprises:
generating the first similarity in the horizontal direction for the plurality of feature maps, by comparing each of a plurality of feature values belonging to one of the plurality of feature maps with a plurality of feature values having the same position in the vertical direction among a plurality of feature values belonging to another one.

5. The optical flow estimation method of claim 4, wherein the generating of the initial flow data further comprises:
generating the second similarity in the vertical direction for the plurality of feature maps, by comparing each of a plurality of feature values belonging to one of the plurality of feature maps with a plurality of feature values having a same position in the horizontal direction among a plurality of feature values belonging to another one.

6. The optical flow estimation method of claim 1, wherein the generating of the initial flow data comprises:
generating the initial flow data by integrating similarity values forming pairs with each other, for a plurality of similarity values belonging to the first similarity and a plurality of similarity values belonging to the second similarity.

7. The optical flow estimation method of claim 1, wherein the generating of the flow data comprises:
estimating a relationship among the initial flow data, the correlation volume, the first similarity, and the second similarity, based on a preset update model; and
correcting the initial flow data by generating a correction value for the initial flow data based on the estimated relationship.

8. The optical flow estimation method of claim 7, wherein the update model is implemented to estimate inconsistency between the initial flow data and the correlation volume, by considering both a relationship among the initial flow data, the correlation volume, the first similarity, and the second similarity, and contextual features for at least one of the plurality of images, based on ConvGRU.

9. An optical flow estimation system, comprising:
a storage in which a plurality of images is stored; and
a control unit configured to generate flow data indicating optical flow for the plurality of images based on the plurality of images,
wherein the control unit:
generates a feature map from each of the plurality of images;
generates a correlation volume by comparing a plurality of feature maps generated from the plurality of images with each other;
compares the plurality of feature maps generated from the plurality of images to generate a first similarity according to comparison in a horizontal direction and a second similarity according to comparison in a vertical direction;
generates initial flow data by integrating the first similarity and the second similarity; and
generates the flow data indicating the optical flow for the plurality of images by correcting the initial flow data based on the correlation volume, the first similarity, and the second similarity.

10. The optical flow estimation system of claim 9,
wherein the control unit is configured to generate the feature map by inputting each of the plurality of images into a convolutional neural network pre-trained to generate a feature map corresponding to a predetermined image, and by acquiring a plurality of feature maps corresponding to the plurality of images, respectively.

11. The optical flow estimation system of claim 9,
wherein the control unit is configured to generate the correlation volume according to all pairs between the plurality of feature maps, by comparing each of a plurality of feature values belonging to one of the plurality of feature maps with a plurality of feature values belonging to another one.

12. The optical flow estimation system of claim 9,
wherein the control unit is configured to generate the first similarity in the horizontal direction for the plurality of feature maps, by comparing each of a plurality of feature values belonging to one of the plurality of feature maps with a plurality of feature values having the same position in the vertical direction among a plurality of feature values belonging to another one.

13. The optical flow estimation system of claim 12,
wherein the control unit is configured to further generate the second similarity in the vertical direction for the plurality of feature maps, by comparing each of a plurality of feature values belonging to one of the plurality of feature maps with a plurality of feature values having the same position in the horizontal direction among a plurality of feature values belonging to another one.

14. The optical flow estimation system of claim 9,
wherein the control unit is configured to generate the initial flow data by integrating similarity values forming pairs with each other, for a plurality of similarity values belonging to the first similarity and a plurality of similarity values belonging to the second similarity.

15. A program stored in a non-transitory computer-readable storage medium, executed by one or more processes in an electronic device, wherein the program includes instructions to perform:
generating a feature map from each of a plurality of images;
generating a correlation volume by comparing a plurality of feature maps generated from the plurality of images with each other;
comparing a plurality of feature maps generated from the plurality of images to generate a first similarity according to comparison in a horizontal direction and a second similarity according to comparison in a vertical direction;
generating initial flow data by integrating the first similarity and the second similarity; and
generating flow data indicating optical flow for the plurality of images by correcting the initial flow data based on the correlation volume, the first similarity, and the second similarity.

16. The non-transitory computer-readable storage medium of claim 15,
wherein the instructions, when executed by one or more processors, cause the one or more processors to generate the feature map by inputting each of the plurality of images into a convolutional neural network pre-trained to generate a feature map corresponding to a predetermined image, and by acquiring a plurality of feature maps corresponding to the plurality of images, respectively.

17. The non-transitory computer-readable storage medium of claim 15,
wherein the instructions, when executed by one or more processors, cause the one or more processors to generate the correlation volume according to all pairs between the plurality of feature maps, by comparing each of a plurality of feature values belonging to one of the plurality of feature maps with a plurality of feature values belonging to another one.

18. The non-transitory computer-readable storage medium of claim 15,
wherein the instructions, when executed by one or more processors, cause the one or more processors to generate the first similarity in the horizontal direction for the plurality of feature maps, by comparing each of a plurality of feature values belonging to one of the plurality of feature maps with a plurality of feature values having the same position in the vertical direction among a plurality of feature values belonging to another one.

19. The non-transitory computer-readable storage medium of claim 18,
wherein the instructions, when executed by one or more processors, cause the one or more processors to further generate the second similarity in the vertical direction for the plurality of feature maps, by comparing each of a plurality of feature values belonging to one of the plurality of feature maps with a plurality of feature values having the same position in the horizontal direction among a plurality of feature values belonging to another one.

20. The non-transitory computer-readable storage medium of claim 15,
wherein the instructions, when executed by one or more processors, cause the one or more processors to generate the initial flow data by integrating similarity values forming pairs with each other, for a plurality of similarity values belonging to the first similarity and a plurality of similarity values belonging to the second similarity.
